(19) United States
(12) Patent Application Publication
(10) Pub. No.: US 2025/0025723 A1
(43) Pub. Date: Jan. 23, 2025

(54) Sprinkler Fire Hose Device

(71) Applicant: Kabaso Masanzi, Pittsburgh, PA (US)

(72) Inventor: Kabaso Masanzi, Pittsburgh, PA (US)

(21) Appl. No.: 18/632,710

(22) Filed: Apr. 11, 2024

Related U.S. Application Data
(60) Provisional application No. 63/514,132, filed on Jul. 18, 2023.

(51) Int. Cl. A62C 3/02; A62C 33/04

(52) U.S. Cl. CPC A62C 3/0264; A62C 33/04

(57) ABSTRACT

A sprinkler fire hose device is provided. The device is comprised of a hose body comprised of at least one opening. The opening allows water to be sprayed from the body once the body is connected to a water source. Flow of water into the body and/or from the openings can be controlled via at least one valve. In this manner, the device can be placed around an area on fire to extinguish fire within the area. The device can also be placed around an area and used to prevent fire from spreading into said area.

### CROSS-REFERENCE TO RELATED APPLICATION

The present application claims priority to, and the benefit of, U.S. Provisional Application No. 63/514,132, which was filed on Jul. 18, 2023, and is incorporated herein by reference in its entirety.

### FIELD OF THE INVENTION

The present invention relates generally to the field of fire-fighting devices. More specifically, the present invention relates to a sprinkler fire hose device that can be deployed around an area to prevent a fire from spreading into said area or to extinguish a fire within said area via spraying water from a plurality of openings on the hose body of the device. Accordingly, the present disclosure makes specific reference thereto. Nonetheless, it is to be appreciated that aspects of the present invention are also equally applicable to other like applications, devices, and methods of manufacture.

### BACKGROUND

Environments that are prone to wildfires often adopt a range of preventative strategies to mitigate the damage caused by these natural disasters. Wildfires, if not controlled in a timely manner, can ravage vast expanses of land, decimating not only the surrounding environment but also causing substantial property damage. The consequences of such fires extend beyond the immediate destruction of vegetation and structures, as they also pose a significant threat to both human and animal life. Injuries or fatalities can result from direct contact with the flames or from the inhalation of toxic smoke generated by the fire.

Further, firefighting teams often face logistical challenges when attempting to fight wildfires. In many cases, firefighting teams are spread thin and may struggle to efficiently tackle fires that are spread over large areas. This delay in response time can lead to the fire spreading uncontrollably, exacerbating the extent of the damage.

Therefore, there exists a long-felt need in the art for a firefighting device. There also exists a long-felt need in the art for a sprinkler fire hose device. Further, there exists a long-felt need in the art for a sprinkler fire hose device that can be used to fight wildfires. More specifically, there exists a long-felt need in the art for a sprinkler fire hose device that can be used to fight wildfires by allowing a user to deploy the device around an area to prevent the spread of a wildfire to said area. In addition, there exists a long-felt need in the art for a sprinkler fire hose device that can be used to fight wildfires by allowing a user to deploy the device around an area to extinguish fire in said area while also preventing the spread of a wildfire to a second area. Finally, there exists a long-felt need in the art for a sprinkler fire hose device that accomplished all of the above, wherein the device can be used via firefighting teams and property owners alike.

The subject matter disclosed and claimed herein, in one embodiment thereof, comprises a sprinkler fire hose device. The device is comprised of a hose body comprised of at least one opening. The opening allows water to be sprayed from the body once the body is connected to a water source. Flow of water into the body and/or from the openings can be controlled via at least one valve. In this manner, the device can be placed around an area on fire to extinguish fire within the area. The device can also be placed around an area and used to prevent fire from spreading into said area.

In this manner, the sprinkler fire hose device of the present invention accomplishes all the forgoing objectives and provides a firefighting device that can be used to fight wildfires. More specifically, the device can be used to fight wildfires by allowing a user to deploy the device around an area to prevent the spread of a wildfire to said area. In addition, the device can be deployed around an area to extinguish fire in said area while also preventing the spread of a wildfire to a second area.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a sprinkler fire hose device comprised of a hose body comprised of at least one opening that can be opened/closed via at least one valve. During use, the body can be placed around an area on fire such that water (or other liquid) is pumped through the body and exits the body via the opening to extinguish a fire.

The device is comprised of a hose body comprised of at least one opening. In the preferred embodiment, the body has a plurality of openings. The openings are preferably positioned on the interior side (i.e., the side of the body that most directly faces the area the body surrounds) of the body. In this manner, water exiting the body via the opening is sprayed directly onto the area. However, the openings may be positioned in any arrangement, pattern, spacing, etc. on the body in different embodiments.

For example, in one embodiment the opening is positioned on the side of the body that most directly faces outward from the area the device is placed around. In this embodiment, the device delivers water around an area (such as but not limited to a house) to prevent fire from encroaching the area. The openings may also be any shape to produce any spray pattern.

In one embodiment, the body is comprised of at least one valve that inhibits the flow of water (or other liquid) through the entire body. In another embodiment, the valve closes the openings such that water cannot flow out from the body via the openings.

In one embodiment, the body is comprised of at least one anchor. The anchor may be fixedly or removably attached to the body. The anchor is preferably spiked or pointed such that it can be easily driven into a ground surface. In this manner, the body can be secured around an area and secure in said position by driving the anchors into the ground surface.

The first end of the body may be comprised of at least one connector. The connector allows the body to attach to a water source such as but not limited to a water pump. The second end of the body may be comprised of at least one end cap. The cap allows for pressure to build within the body such that water pumped through the body is expelled from the openings.

The present invention is also comprised of a method of using the device. First, a device is provided comprised of a hose body comprised of a first end comprised of at least one connector, at least one opening, and at least one valve. Then, the body can be connected to a water source, such as but not limited to a water pump, via attaching the connector to the water source. Next, the body can be positioned around an area where a fire may be present (or where a fire may likely occur). Then, the valve can be set to an open position such that water can flow through the body and out of the opening. The opening of the valve may open the opening of the body or simply allow water to flow into the body. Finally, the valve can be set to a closed position such that water cannot flow through the body and out of the opening. The closing of the valve may close the opening of the body or simply prevent water from flowing into the body.

The present invention is also comprised of a second method of using the device. First, a device is provided comprised of a hose body comprised of a first end comprised of at least one connector, at least one anchor, at least one opening, and at least one valve. Then, the body can be connected to a water source, such as but not limited to a water pump, via attaching the connector to the water source. Next, the body can be positioned around an area where a fire may be present (or where a fire may likely occur) and the anchor can be driven into a ground surface to secure the position of the body. Then, the valve can be set to an open position such that water can flow through the body and out of the opening. The opening of the valve may open the opening of the body or simply allow water to flow into the body. Finally, the valve can be set to a closed position such that water cannot flow through the body and out of the opening. The closing of the valve may close the opening of the body or simply prevent water from flowing into the body.

Accordingly, the sprinkler fire hose device of the present invention is particularly advantageous as it provides a firefighting device that can be used to fight wildfires. More specifically, the device can be used to fight wildfires by allowing a user to deploy the device around an area to prevent the spread of a wildfire to said area. In addition, the device can be deployed around an area to extinguish fire in said area while also preventing the spread of a wildfire to a second area. In this manner, the sprinkler fire hose device provides a solution to extinguishing and preventing the spread of wildfires in specific areas.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of a sprinkler fire hose device of the present invention in accordance with the disclosed architecture;

FIG. 2 illustrates a top perspective view of one potential embodiment of a sprinkler fire hose device of the present invention while extinguishing a fire in the area around the device in accordance with the disclosed architecture;

FIG. 3 illustrates a top perspective view of one potential embodiment of a sprinkler fire hose device of the present invention while preventing the spread of a fire into the area around the device in accordance with the disclosed architecture;

FIG. 4 illustrates a flowchart of a method of using one potential embodiment of a sprinkler fire hose device of the present invention in accordance with the disclosed architecture;

FIG. 5 illustrates a flowchart of a method of using one potential embodiment of a sprinkler fire hose device of the present invention in accordance with the disclosed architecture; and

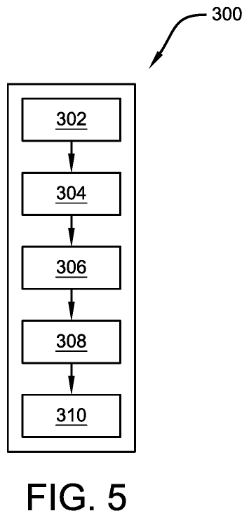

FIG. 6 illustrates a side view of accessories of one potential embodiment of a sprinkler fire hose device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a firefighting device. There also exists a long-felt need in the art for a sprinkler fire hose device. Further, there exists a long-felt need in the art for a sprinkler fire hose device that can be used to fight wildfires. More specifically, there exists a long-felt need in the art for a sprinkler fire hose device that can be used to fight wildfires by allowing a user to deploy the device around an area to prevent the spread of a wildfire to said area. In addition, there exists a long-felt need in the art for a sprinkler fire hose device that can be used to fight wildfires by allowing a user to deploy the device around an area to extinguish fire in said area while also preventing the spread of a wildfire to a second area. Finally, there exists a long-felt need in the art for a sprinkler fire hose device that accomplished all of the above, wherein the device can be used via firefighting teams and property owners alike.

The present invention, in one exemplary embodiment, is comprised of a sprinkler fire hose device comprised of a hose body comprised of at least one opening that can be opened/closed via at least one valve. During use, the body can be placed around an area on fire such that water (or other liquid) is pumped through the body and exits the body via the opening to extinguish a fire.

The device is comprised of a hose body comprised of at least one opening. In the preferred embodiment, the body has a plurality of openings preferably positioned on the interior side (i.e., the side of the body that most directly faces the area the body surrounds) of the body. In this manner, water exiting the body via the opening is sprayed directly onto the area. However, the openings may be positioned in any arrangement, pattern, spacing, etc. on the body in different embodiments.

For example, in one embodiment the opening is positioned on the side of the body that most directly faces outward from the area the device is placed around. In this embodiment, the device delivers water around an area (such as but not limited to a house) to prevent fire from encroaching on the area. The openings may also be any shape to produce any spray pattern.

In one embodiment, the body is comprised of at least one valve that inhibits the flow of water (or other liquid) through the entire body. In another embodiment, the valve closes the openings such that water cannot flow out from the body via the openings.

In one embodiment, the body is comprised of at least one anchor. The anchor may be fixedly or removably attached to the body. The anchor is preferably spiked or pointed such that it can be easily driven into a ground surface. In this manner, the body can be secured around an area and secure in said position by driving the anchors into the ground surface.

The first end of the body may be comprised of at least one connector. The connector allows the body to attach to a water source such as but not limited to a water pump. The second end of the body may be comprised of at least one end cap. The cap allows for pressure to build within the body such that water pumped through the body is expelled from the openings.

The present invention is also comprised of a method of using the device. First, a device is provided comprised of a hose body comprised of a first end comprised of at least one connector, at least one opening, and at least one valve. Then, the body can be connected to a water source, such as but not limited to a water pump, via attaching the connector to the water source. Next, the body can be positioned around an area where a fire may be present (or where a fire may likely occur). Then, the valve can be set to an open position such that water can flow through the body and out of the opening. The opening of the valve may open the opening of the body or simply allow water to flow into the body. Finally, the valve can be set to a closed position such that water cannot flow through the body and out of the opening. The closing of the valve may close the opening of the body or simply prevent water from flowing into the body.

The present invention is also comprised of a second method of using the device. First, a device is provided comprised of a hose body comprised of a first end comprised of at least one connector, at least one anchor, at least one opening, and at least one valve. Then, the body can be connected to a water source, such as but not limited to a water pump, via attaching the connector to the water source. Next, the body can be positioned around an area where a fire may be present (or where a fire may likely occur) and the anchor can be driven into a ground surface to secure the position of the body. Then, the valve can be set to an open position such that water can flow through the body and out of the opening. The opening of the valve may open the opening of the body or simply allow water to flow into the body. Finally, the valve can be set to a closed position such that water cannot flow through the body and out of the opening. The closing of the valve may close the opening of the body or simply prevent water from flowing into the body.

Accordingly, the sprinkler fire hose device of the present invention is particularly advantageous as it provides a firefighting device that can be used to fight wildfires. More specifically, the device can be used to fight wildfires by allowing a user to deploy the device around an area to prevent the spread of a wildfire to said area. In addition, the device can be deployed around an area to extinguish fire in said area while also preventing the spread of a wildfire to a second area. In this manner, the sprinkler fire hose device provides a solution to extinguishing and preventing the spread of wildfires in specific areas.

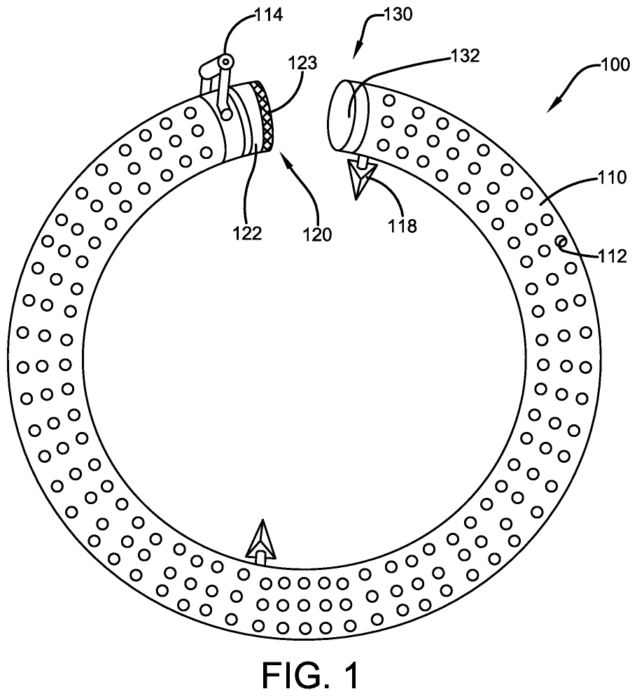

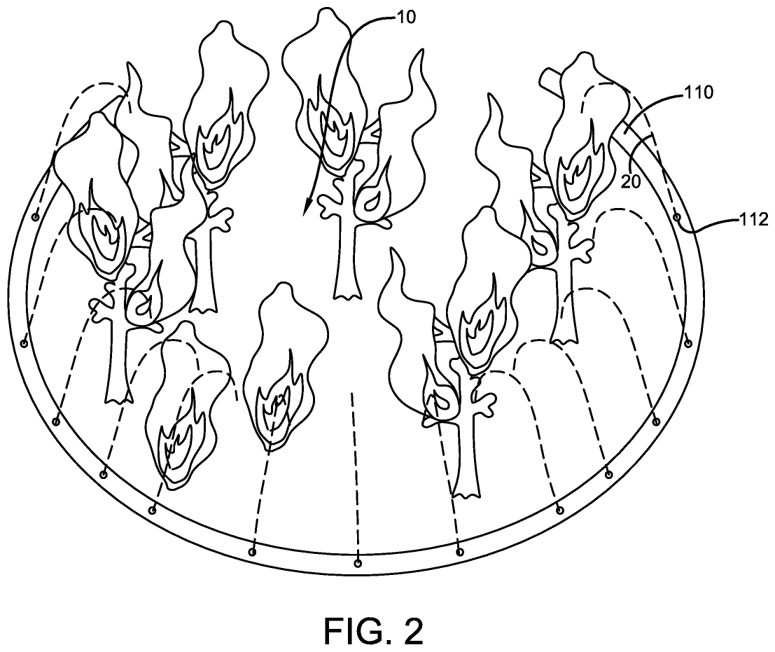

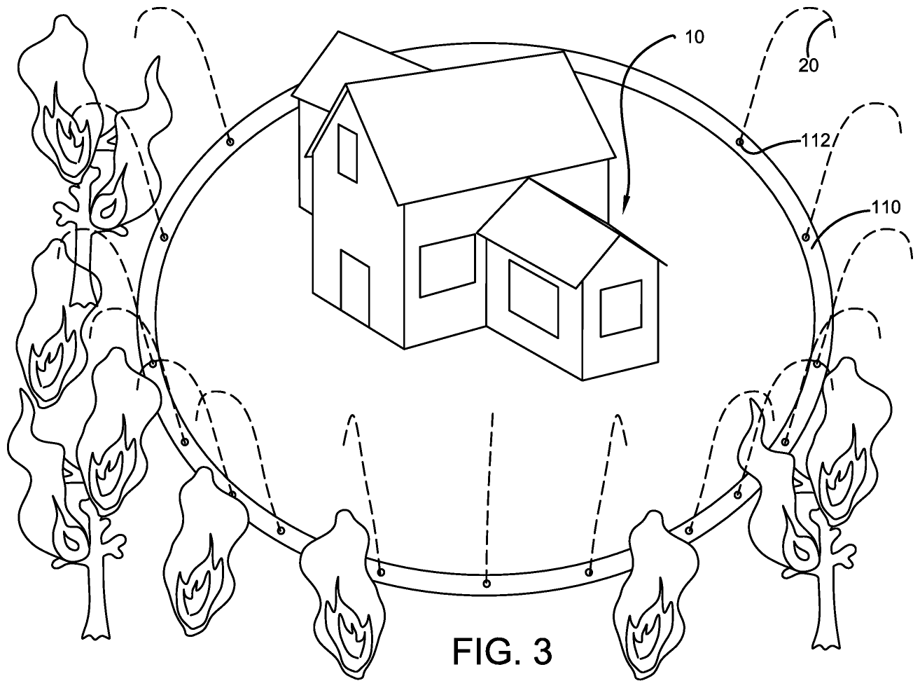

Referring initially to the drawings, FIG. 1 illustrates a top view of one potential embodiment of a sprinkler fire hose device 100 of the present invention in accordance with the disclosed architecture. The device 100 is comprised of a hose body 110 comprised of at least one opening 112 that can be opened/closed via at least one valve 114. During use, the body 110 can be placed around an area 10 on fire such that water 20 (or other liquid) is pumped through the body 110 and exits the body 110 via the opening 112 to extinguish a fire (as seen in FIG. 2) or prevent the spread of fire into an area 10 (as seen in FIG. 3).

The device 100 is comprised of a hose body 110. The body 110 is preferably tubular. The body 110 may be made from any hose material known in the art. This includes, but is not limited to rubber, PVC, polyurethane, silicone, metal, Teflon, nylon, polyester, rubber-coated material, etc. The body 110 may be any length.

The body 110 is comprised of at least one opening 112. In the preferred embodiment, the body 110 has a plurality of openings 112. The openings 112 are preferably positioned on the interior side 111 (i.e., the side of the body 110 that most directly faces the area the body 110 surrounds) of the body 110. In this manner, water 20 exiting the body 110 via the opening 112 is sprayed directly onto the area 10. However, the openings 112 may be positioned in any arrangement, pattern, spacing, etc. on the body 110 in different embodiments. For example, in one embodiment the opening 112 is positioned on the side of the body 110 that most directly faces outward from the area 10 the device 100 is placed around. In this embodiment the device 100 delivers water around an area 10 (such as but not limited to a house) to prevent fire from encroaching the area 10. The openings 112 may also be any shape to produce any spray pattern.

In one embodiment, the body 110 is comprised of at least one valve 114. In one embodiment, the valve 114 inhibits the flow of water 20 (or other liquid) through the entire body 110. In another embodiment, the valve 114 closes the openings 112 such that water 20 cannot flow out from the body 110 via the openings 112. The valve 114 may be any water-tight, flow-inhibiting valve known in the art.

In one embodiment, the body 110 is comprised of at least one anchor 118. The anchor 118 may be fixedly or removably attached to the body 110. The anchor 118 is preferably spiked or pointed such that it can be easily driven into a ground surface. In this manner, the body 110 can be secured around and area 10 and secure in said position by driving the anchors 118 into the ground surface. The anchor 118 may be any anchor or spike shape in different embodiments. The anchor 118 can be driven into the ground via at least one claw hammer 140.

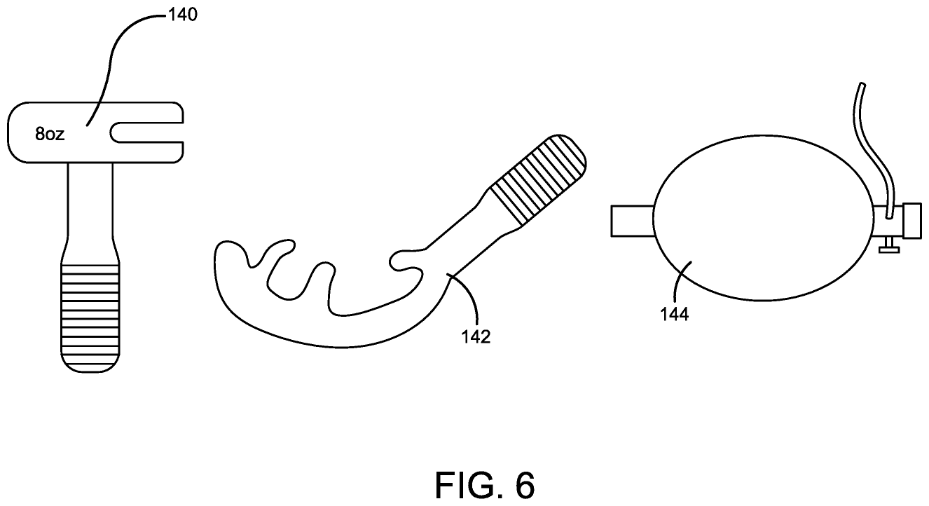

The first end 120 of the body 110 may be comprised of at least one connector 122. The connector 122 allows the body 110 to attach to a water source such as but not limited to a water pump. The connector 122 may be any type of hose connector such as but not limited to a threaded connector, a quick-connect coupling, a barbed connector, a compression fitting, a bayonet connector, a clamp connector, a fire hose connector, etc. In this manner, the body 110 can be easily connected to, and placed in fluid connection with, a water source. In one embodiment, the device 100 may also be comprised of a spanner wrench 142. In one embodiment, the device 100 is comprised of at least one attachable floatation device 144, as seen in FIG. 6, such as but not limited to an inflatable bag, that allows the first end 120 to float in a body of water.

The second end 130 of the body 110 may be comprised of at least one end cap 132. The cap 132 may be fixedly attached or removably attached to the second end 130 in different embodiments. The cap 132 allows for pressure to build within the body 110 such that water pumped through the body 110 is expelled from the openings 112.

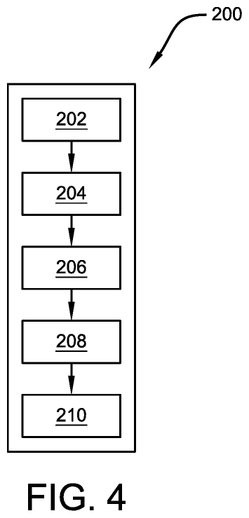

The present invention is also comprised of a method of using 200 the device 100, as seen in FIG. 4. First, a device 100 is provided comprised of a hose body 110 comprised of a first end 120 comprised of at least one connector 122, at least one opening 112, at least one valve 114 [Step 202]. Then, the body 110 can be connected to a water source, such as but not limited to a water pump, via attaching the connector 122 to the water source [Step 204]. Next, the body 110 can be positioned around an area 10 where a fire may be present (or where a fire may likely occur), as seen in FIG. 2 and FIG. 3 [Step 206]. Then, the valve 114 can be set to an open position such that water 20 can flow through the body 110 and out of the opening 112 [Step 208]. The opening of the valve 114 may open the opening 112 of the body 110 or simply allow water to flow into the body 110. Finally, the valve 114 can be set to a closed position such that water 20 cannot flow through the body 110 and out of the opening 112 [Step 210]. The closing of the valve 114 may close the opening 112 of the body 110 or simply prevent water from flowing into the body 110.

The present invention is also comprised of a second method of using 300 the device 100. First, a device 100 is provided comprised of a hose body 110 comprised of a first end 120 comprised of at least one connector 122, at least one anchor 118, at least one opening 112, at least one valve 114 [Step 302]. Then, the body 110 can be connected to a water source, such as but not limited to a water pump, via attaching the connector 122 to the water source [Step 304]. Next, the body 110 can be positioned around an area 10 where a fire may be present (or where a fire may likely occur), as seen in FIG. 2 and FIG. 3, and the anchor 118 can be driven into a ground surface to secure the position of the body 110 [Step 306]. Then, the valve 114 can be set to an open position such that water 20 can flow through the body 110 and out of the opening 112 [Step 308]. The opening of the valve 114 may open the opening 112 of the body 110 or simply allow water 20 to flow into the body 110. Finally, the valve 114 can be set to a closed position such that water cannot flow through the body 110 and out of the opening 112 [Step 310]. The closing of the valve 114 may close the opening 112 of the body 110 or simply prevent water from flowing into the body 110.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “sprinkler fire hose device” and “device” are interchangeable and refer to the sprinkler fire hose device 100 of the present invention.

Notwithstanding the forgoing, the sprinkler fire hose device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the sprinkler fire hose device 100 as shown in the FIGS. are for illustrative purposes only, and that many other sizes and shapes of the sprinkler fire hose device 100 are well within the scope of the present disclosure. Although the dimensions of the sprinkler fire hose device 100 are important design parameters for user convenience, the sprinkler fire hose device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sprinkler fire hose device comprising:
a body comprised of a first end, the first end comprised of a connector;
an opening; and
and a valve that allows and inhibits the flow of a liquid into the body.

2. The sprinkler fire hose device of claim 1, wherein the body is comprised of a tubular hose body.

3. The sprinkler fire hose device of claim 1, wherein the body is comprised of a rubber, a PVC, a polyurethane, a silicone, a metal, a Teflon, a nylon, a polyester, or a rubber-coated material.

4. The sprinkler fire hose device of claim 1 comprised of an anchor.

5. The sprinkler fire hose device of claim 4, wherein the anchor is attached to the body.

6. The sprinkler fire hose device of claim 4, wherein the anchor is comprised of a spike or a point.

7. The sprinkler fire hose device of claim 1, wherein the connector is comprised of a threaded connector, a quick-connect coupling, a barbed connector, a compression fitting, a bayonet connector, a clamp connector, or a fire hose connector.

8. The sprinkler fire hose device of claim 1, wherein the body is comprised of an end cap.

9. A sprinkler fire hose device comprising:
a body comprised of a first end, the first end comprised of a connector;
an opening; and
and a valve that opens and closes the opening.

10. The sprinkler fire hose device of claim 9, wherein the body is comprised of a tubular hose body.

11. The sprinkler fire hose device of claim 9, wherein the body is comprised of a rubber, a PVC, a polyurethane, a silicone, a metal, a Teflon, a nylon, a polyester, or a rubber-coated material.

12. The sprinkler fire hose device of claim 9 comprised of an anchor.

13. The sprinkler fire hose device of claim 12, wherein the anchor is attached to the body.

14. The sprinkler fire hose device of claim 12, wherein the anchor is comprised of a spike or a point.

15. The sprinkler fire hose device of claim 9, wherein the connector is comprised of a threaded connector, a quick-connect coupling, a barbed connector, a compression fitting, a bayonet connector, a clamp connector, or a fire hose connector.

16. The sprinkler fire hose device of claim 9, wherein the body is comprised of an end cap.

17. A method of using a sprinkler fire hose device, the method comprising:
providing a sprinkler fire hose device comprised of a hose body comprised of an opening, a valve, and a connector;
attaching the connector to a water source;
positioning the body around an area;
opening the valve; and
closing the valve.

18. The method of using a sprinkler fire hose device of claim 17, wherein closing the valve closes the opening.

19. The method of using a sprinkler fire hose device of claim 17, wherein opening the valve opens the opening.

20. The method of using a sprinkler fire hose device of claim 17, wherein closing the valve inhibits the ability for a liquid to flow through the body.
